(19) United States
(12) Patent Application Publication
(10) Pub. No.: US 2022/0231963 A1
(43) Pub. Date: Jul. 21, 2022

(54) RESOURCE MANAGEMENT DEVICE, CONTROL CIRCUIT, STORAGE MEDIUM, AND RESOURCE MANAGEMENT METHOD

(71) Applicant: Mitsubishi Electric Corporation, Tokyo (JP)

(72) Inventors: Akiko IWASAKI, Tokyo (JP); Kenichi NAKURA, Tokyo (JP); Takeshi SUEHIRO, Tokyo (JP); Seiji KOZAKI, Tokyo (JP)

(73) Assignee: Mitsubishi Electric Corporation, Tokyo (JP)

(21) Appl. No.: 17/714,498

(22) Filed: Apr. 6, 2022

Related U.S. Application Data
(63) Continuation of application No. PCT/JP2019/049234, filed on Dec. 16, 2019.

(51) Int. Cl. H04L 47/70

(52) U.S. Cl. CPC H04L 47/70

(57) ABSTRACT

A controller that is a resource management device includes: a history information storage unit storing, for each combination of endpoint nodes constituting endpoints of a network and for each type of service, history information indicating used bands previously required for providing a service; a non-used resource calculation unit calculating non-used resource information based on the history information stored corresponding to a first service that is a service already allocated a resource, the non-used resource information indicating a resource that is not used while the first service is provided; and an available resource generation unit generating available resource information based on the non-used resource information, the available resource information indicating an available resource including a shareable resource and available to a second service to be newly provided, the shareable resource being a part, shareable with the second service, of the resource already allocated to the first service.

### CROSS-REFERENCE TO RELATED APPLICATION

This application is a continuation application of International Application PCT/JP2019/049234, filed on Dec. 16, 2019, and designating the U.S., the entire contents of which are incorporated herein by reference.

### BACKGROUND OF THE INVENTION

### 1. Field of the Invention

The disclosure relates to a resource management device, a control circuit, a storage medium, and a resource management method for managing network resources.

### 2. Description of the Related Art

In recent years, increasingly diversified services have demanded the construction of a network that can support the requirements of various services. To meet this demand, a method of constructing slices, i.e. virtual networks, on a single physical network has been studied. In the method of constructing slices on a physical network, it is necessary to allocate appropriate resources to individual services so as to meet the requirements of the services.

For example, Japanese Patent Application Laid-open No. 2015-185883 discloses a method for allocating resources to a guaranteed service that ensures service quality and a best-effort service that does not ensure service quality. Specifically, the method includes allocating the best-effort service a resource in advance on the basis of resource information required by the best-effort service, then determining whether it is possible to allocate the guaranteed service the requested resource, and allocating resources to the best-effort service and the guaranteed service in response to determining that the allocation is possible. With this method, it is possible to satisfy the service quality required by the guaranteed service and also improve the quality of the best-effort service provided in the same network.

However, according to the above-described conventional technique, at the time of allocating a resource to the guaranteed service after the resource allocation to the best-effort service, resources that can be allocated to the guaranteed service are unknown. For this reason, if it is determined that the resource requested by the guaranteed service cannot be allocated, it is necessary to change the resource allocated to the best-effort service and determine whether the resource requested by the guaranteed service can be allocated, and this process needs to be repeated until it is determined that the allocation is possible. Therefore, it takes time to determine whether resource allocation is possible, which is problematic. Thus, the technique described in Japanese Patent Application Laid-open No. 2015-185883 is unsuitable in cases where immediate service provision or immediate change in a service-level agreement (SLA) is required.

### SUMMARY OF THE INVENTION

In order to solve the above-described problems and achieve an object, a resource management device according to the disclosure includes: a history information storage unit to store, for each combination of endpoint nodes constituting endpoints of a network and for each type of service, history information indicating used bands previously required for providing a service; a non-used resource calculation unit to calculate non-used resource information on the basis of the history information stored corresponding to a first service that is a service already allocated a resource, the non-used resource information indicating a resource that is not used while the first service is provided; and an available resource generation unit to generate available resource information on the basis of the non-used resource information, the available resource information indicating an available resource including a shareable resource and available to a second service to be newly provided, the shareable resource being a part, shareable with the second service, of the resource already allocated to the first service.

### BRIEF DESCRIPTION OF THE DRAWINGS

FIG. 1 is a diagram illustrating a configuration of a system according to a first embodiment;

FIG. 2 is a diagram illustrating a functional configuration of the controller illustrated in FIG. 1;

FIG. 3 is a diagram illustrating endpoint node information of the system illustrated in FIG. 1;

FIG. 4 is a diagram illustrating an example of network device information of the system illustrated in FIG. 1;

FIG. 5 is a diagram illustrating an example of connection information of the system illustrated in FIG. 1;

FIG. 6 is a diagram illustrating an example of physical resource information generated by the physical resource generation unit illustrated in FIG. 2;

FIG. 7 is a diagram illustrating an example of occupiable resource information generated by the occupiable resource calculation unit illustrated in FIG. 2;

FIG. 8 is a diagram illustrating an example of history information stored in the history information storage unit illustrated in FIG. 2;

FIG. 9 is a diagram illustrating an example of non-used resource information generated by the non-used resource calculation unit illustrated in FIG. 2;

FIG. 10 is a diagram illustrating an example of shareable resource information generated by the shareable resource calculation unit illustrated in FIG. 2;

FIG. 11 is a diagram illustrating an example of available resource information generated by the available resource generation unit illustrated in FIG. 2;

FIG. 12 is a diagram for explaining classification of the resources illustrated in FIG. 1;

FIG. 13 is a diagram illustrating an exemplary physical configuration of the controller illustrated in FIG. 2;

FIG. 14 is a flowchart for explaining the operation of the controller illustrated in FIG. 2;

FIG. 15 is a diagram illustrating an example of allocated physical resource information received in step S103 of FIG. 14;

FIG. 16 is a diagram illustrating an example of physical resource information generated in step S104 of FIG. 14;

FIG. 17 is a diagram illustrating an example of occupiable resource information generated in step S104 of FIG. 14;

FIG. 18 is a diagram illustrating an example of available resource information generated in step S108 of FIG. 14;

FIG. 19 is a diagram illustrating a first example of available resources calculated in a second embodiment;

FIG. 20 is a diagram illustrating service requirements required in the second embodiment;

FIG. 21 is a diagram illustrating physical resources allocated when the services illustrated in FIG. 20 are requested;

FIG. 22 is a diagram illustrating an example of non-used resources calculated in the second embodiment;

FIG. 23 is a diagram illustrating a second example of available resources calculated in the second embodiment;

FIG. 24 is a diagram illustrating a third example of available resources calculated in the second embodiment; and

FIG. 25 is a diagram illustrating a fourth example of available resources calculated in the second embodiment.

### DETAILED DESCRIPTION OF THE PREFERRED EMBODIMENTS

Hereinafter, a resource management device, a control circuit, a storage medium, and a resource management method according to embodiments of the disclosure will be described in detail with reference to the drawings.

### First Embodiment

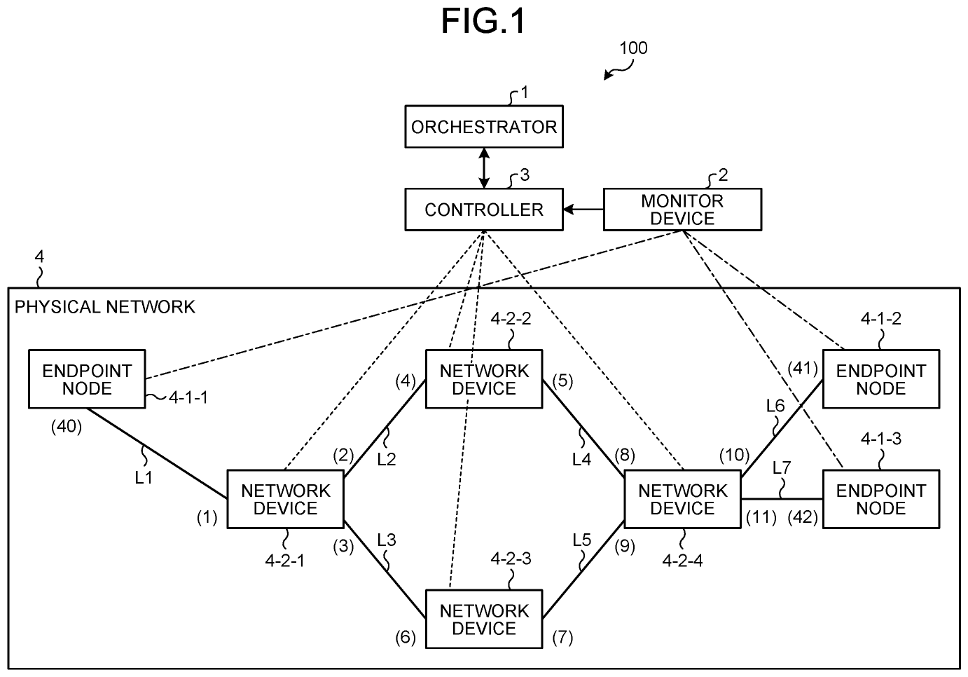

FIG. 1 is a diagram illustrating a configuration of a system 100 according to a first embodiment. The system 100 includes an orchestrator 1, a monitor device 2, a controller 3, and a physical network 4. The physical network 4 includes a plurality of endpoint nodes 4-1-1 to 4-1-3 and a plurality of network devices 4-2-1 to 4-2-4.

In the following description, the endpoint nodes 4-1-1 to 4-1-3 may be simply referred to as the endpoint node(s) 4-1 when they are not distinguished, and the network devices 4-2-1 to 4-2-4 may be simply referred to as the network device(s) 4-2 when they are not distinguished. For the sake of simplicity, the illustrated example shows the three endpoint nodes 4-1-1 to 4-1-3 and the four network devices 4-2-1 to 4-2-4. However, there is no restriction on the number of endpoint nodes 4-1 and the number of network devices 4-2 included in the physical network 4.

The orchestrator 1 has a function of notifying the controller 3 of service request information. The monitor device 2 has a function of acquiring the used bands associated with each service transmitted and received by the endpoint nodes 4-1 and of notifying the controller 3 of the used bands.

On the physical network 4, it is possible to construct a plurality of slices, i.e. virtual networks, and provide different services using different slices. The controller 3 changes the settings of the network devices 4-2 on the basis of the service request information provided by the orchestrator 1, thereby allocating the slices communication resources that satisfy the requirements of the requested service.

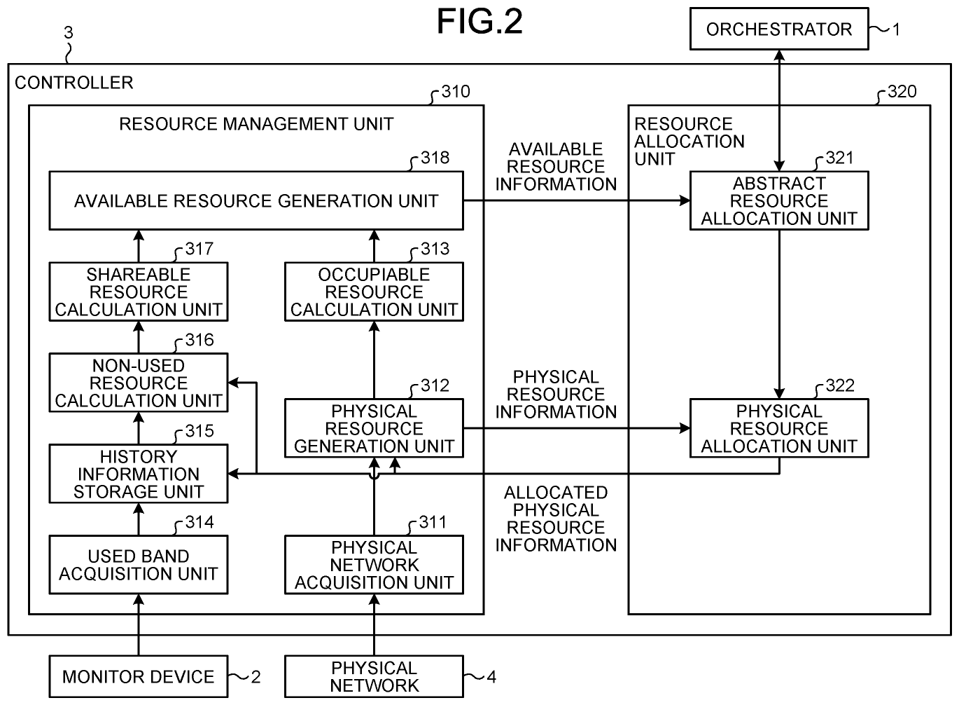

FIG. 2 is a diagram illustrating a functional configuration of the controller 3 illustrated in FIG. 1. The controller 3 includes a resource management unit 310 and a resource allocation unit 320. In other words, the controller 3 has both the function of a resource management device and the function of a resource allocation device.

The resource management unit 310 includes a physical network acquisition unit 311, a physical resource generation unit 312, an occupiable resource calculation unit 313, a used band acquisition unit 314, a history information storage unit 315, a non-used resource calculation unit 316, a shareable resource calculation unit 317, and an available resource generation unit 318.

The resource allocation unit 320 includes an abstract resource allocation unit 321 and a physical resource allocation unit 322.

The physical network acquisition unit 311 acquires physical network information including endpoint node information 120, network device information 130, and connection information 140, and notifies the physical resource generation unit 312 of the acquired physical network information. For example, the physical network acquisition unit 311 may acquire physical network information by making an inquiry about physical network information to each device, may acquire physical network information using a route search protocol, or may acquire physical network information by reading information held by the network administrator.

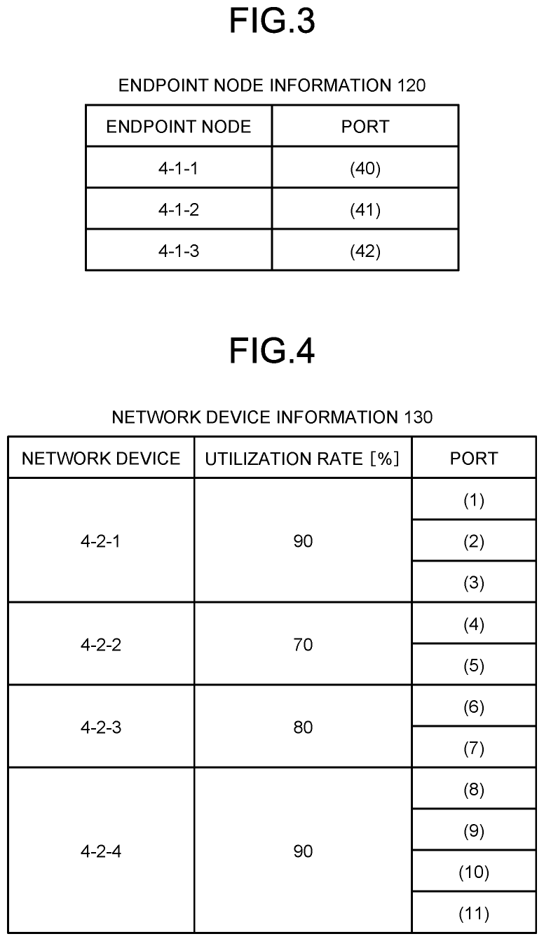

FIG. 3 is a diagram illustrating the endpoint node information 120 of the system 100 illustrated in FIG. 1. The endpoint node information 120 is information in which information for identifying the endpoint node 4-1 is associated with the port number of the endpoint node 4-1. The endpoint node information 120 indicates that the endpoint node 4-1-1 has the port (40), the endpoint node 4-1-2 has the port (41), and the endpoint node 4-1-3 has the port (42).

FIG. 4 is a diagram illustrating an example of the network device information 130 of the system 100 illustrated in FIG. 1. The network device information 130 is information in which information for identifying the network device 4-2, the utilization rate of the network device 4-2, and the port number of the network device 4-2 are associated with each other.

The network device information 130 indicates that the utilization rate of the network device 4-2-1 is 90%, and the network device 4-2-1 has the port (1), the port (2), and the port (3). The network device information 130 indicates that the utilization rate of the network device 4-2-2 is 70%, and the network device 4-2-2 has the port (4) and the port (5). The network device information 130 indicates that the utilization rate of the network device 4-2-3 is 80%, and the network device 4-2-3 has the port (6) and the port (7). The network device information 130 indicates that the utilization rate of the network device 4-2-4 is 90%, and the network device 4-2-4 has the port (8), the port (9), the port (10), and the port (11).

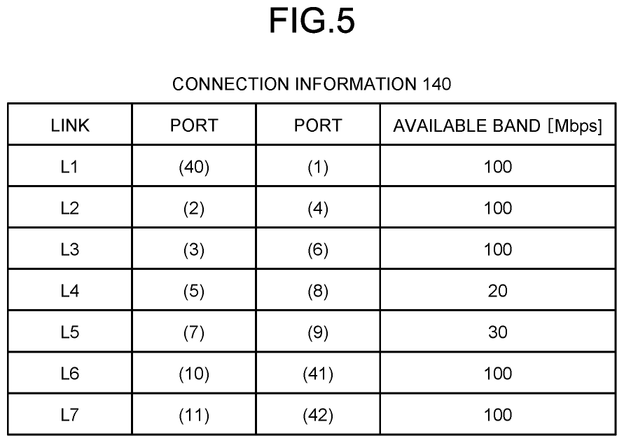

FIG. 5 is a diagram illustrating an example of the connection information 140 of the system 100 illustrated in FIG. 1. The connection information 140 is information in which information for identifying links, i.e. connections between the endpoint node 4-1 and the network device 4-2 and between the network devices 4-2, port numbers constituting the links, and the available band of each link are associated with each other. Note that the connection information 140 may be managed separately for each communication direction.

The connection information 140 illustrated in FIG. 5 indicates that the link L1 is configured by the port (40) and the port (1), and the available band thereof is 100 Mbps. The connection information 140 indicates that the link L2 is configured by the port (2) and the port (4), and the available band thereof is 100 Mbps. The connection information 140 indicates that the link L3 is configured by the port (3) and the port (6), and the available band thereof is 100 Mbps. The connection information 140 indicates that the link L4 is configured by the port (5) and the port (8), and the available band thereof is 20 Mbps. The connection information 140 indicates that the link L5 is configured by the port (7) and the port (9), and the available band thereof is 30 Mbps. The connection information 140 indicates that the link L6 is configured by the port (10) and the port (41), and the available band thereof is 100 Mbps. The connection information 140 indicates that the link L7 is configured by the port (11) and the port (42), and the available band thereof is 100 Mbps.

Returning to FIG. 2, the physical resource generation unit 312 generates physical resource information on the basis of the physical network information received from the physical network acquisition unit 311. Upon receiving allocated physical resource information from the physical resource allocation unit 322, the physical resource generation unit 312 updates the physical resource information on the basis of the received allocated physical resource information. The physical resource generation unit 312 notifies the occupiable resource calculation unit 313 and the physical resource allocation unit 322 of the generated physical resource information.

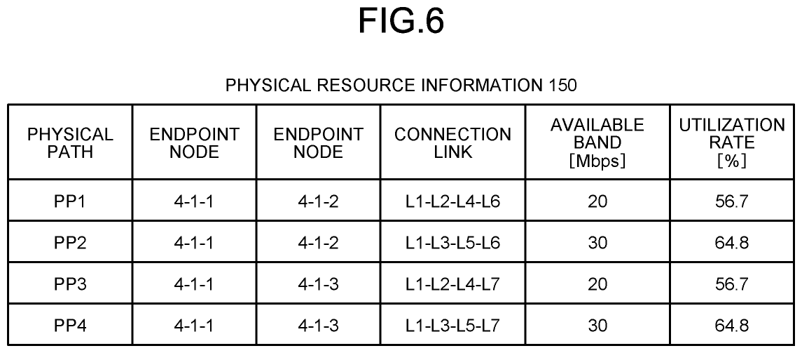

FIG. 6 is a diagram illustrating an example of physical resource information 150 generated by the physical resource generation unit 312 illustrated in FIG. 2. The physical resource information 150 illustrated in FIG. 6 is generated on the basis of the physical network information illustrated in FIGS. 3 to 5. The physical resource information 150 indicates the physical resource information held by each physical path, i.e. a route connecting two endpoint nodes 4-1. Specifically, the physical resource information 150 includes information for identifying a physical path, information for identifying the two endpoint nodes constituting the endpoints of the physical path, information indicating the connection relationship between the links constituting the physical path, the available band of the physical path, and the utilization rate of the physical path. The available band is a bottleneck band having the minimum value among the available bands of all the links constituting the physical path. On the basis of the utilization rates of the network devices 4-2 constituting each physical path, the physical resource generation unit 312 calculates the utilization rate while taking into consideration the connection relationship between the network devices 4-2, for example, whether the network devices 4-2 are connected in series or in parallel. In addition, the physical resource information 150 may include parameters such as delay time and traffic discard ratio, which are not illustrated here.

For example, the physical path PP1 is a route connecting the endpoint node 4-1-1 and the endpoint node 4-1-2, and includes the links L1, L2, L4, and L6. The available band of the physical path PP1 is 20 Mbps: the minimum value among the available bands of the links L1, L2, L4, and L6, namely 100, 100, 20, and 100 Mbps. The physical path PP1 is configured using the network devices 4-2-1, 4-2-2, and 4-2-4, and these network devices 4-2 are connected in series. Therefore, the utilization rate of the physical path PP1 is obtained by multiplying the utilization rates of the network devices 4-2-1, 4-2-2, and 4-2-4. Specifically, the utilization rate of the physical path PP1 is 0.9×0.7×0.9×100=56.7%.

The physical path PP2 is a route connecting the endpoint node 4-1-1 and the endpoint node 4-1-2, and includes the links L1, L3, L5, and L6. The available band of the physical path PP2 is 30 Mbps: the minimum value among the available bands of the links L1, L3, L5, and L6, namely 100, 100, 30, and 100 Mbps. The physical path PP2 is configured using the network devices 4-2-1, 4-2-3, and 4-2-4, and these network devices 4-2 are connected in series. Therefore, the utilization rate of the physical path PP2 is obtained by multiplying the utilization rates of the network devices 4-2-1, 4-2-3, and 4-2-4. Specifically, the utilization rate of the physical path PP2 is 0.9×0.8×0.9×100=64.8%.

The physical path PP3 is a route connecting the endpoint node 4-1-1 and the endpoint node 4-1-3, and includes the links Ll, L2, L4, and L7. The available band of the physical path PP3 is 20 Mbps: the minimum value among the available bands of the links Ll, L2, L4, and L7, namely 100, 100, 20, and 100. The physical path PP3 is configured using the network devices 4-2-1, 4-2-2, and 4-2-4, and these network devices 4-2 are connected in series. Therefore, the utilization rate of the physical path PP3 is obtained by multiplying the utilization rates of the network devices 4-2-1, 4-2-2, and 4-2-4. Specifically, the utilization rate of the physical path PP3 is 0.9×0.7×0.9×100=56.7%.

The physical path PP4 is a route connecting the endpoint node 4-1-1 and the endpoint node 4-1-3, and includes the links L1, L3, L5, and L7. The available band of the physical path PP4 is 30 Mbps: the minimum value among the available bands of the links L1, L3, L5, and L7, namely 100, 100, 30, and 100 Mbps. The physical path PP4 is configured using the network devices 4-2-1, 4-2-3, and 4-2-4, and these network devices 4-2 are connected in series. Therefore, the utilization rate of the physical path PP4 is obtained by multiplying the utilization rates of the network devices 4-2-1, 4-2-3, and 4-2-4. Specifically, the utilization rate of the physical path PP4 is 0.9×0.8×0.9×100=64.8%.

Here, a calculation method for obtaining the utilization rate of a physical path linking a plurality of network devices 4-2 connected in parallel will be described, which can be implemented in the case of using link aggregation. For example, consider a parallel-connected physical path connecting the endpoint node 4-1-1 and the endpoint node 4-1-2 through both the network devices 4-2-2 and 4-2-3. In this case, the utilization rate of the parallel section of the physical path is expressed by Formula (1) below.

(Utilization rate of parallel section)=1−(1−Utilization rate of network device 4-22)×(1-Utilization rate of network device 4-2-3) (1)

In this case, the utilization rate of the parallel-connected physical path is obtained by multiplying the utilization rate of the network device 4-2-1, the utilization rate of the parallel section obtained using Formula (1), and the utilization rate of the network device 4-2-4.

Returning to FIG. 2, the occupiable resource calculation unit 313 calculates occupiable resource information 160 on the basis of the physical resource information 150 received from the physical resource generation unit 312. The occupiable resource calculation unit 313 notifies the available resource generation unit 318 of the calculated occupiable resource information 160.

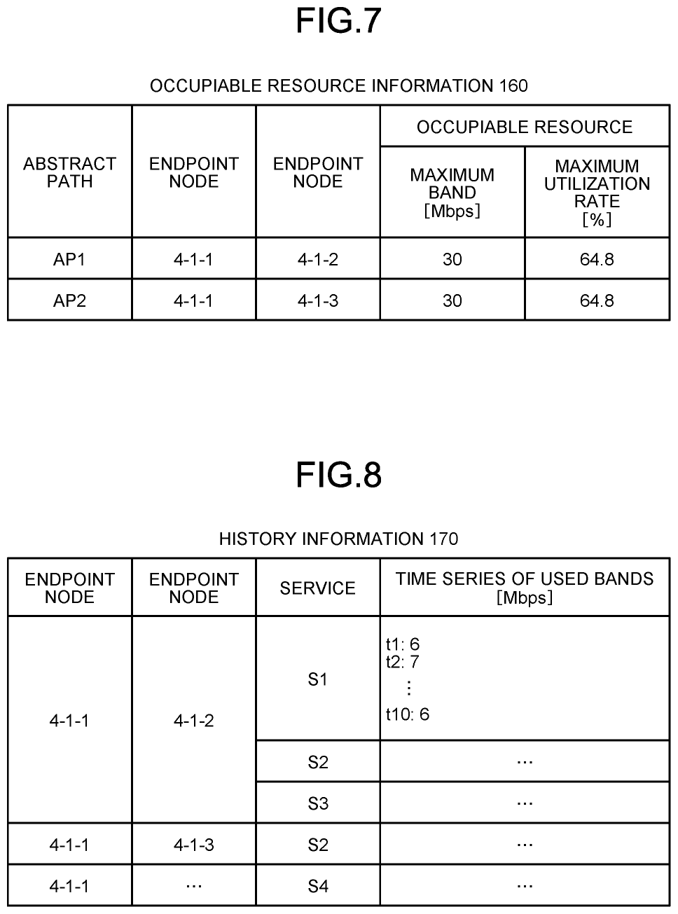

FIG. 7 is a diagram illustrating an example of the occupiable resource information 160 generated by the occupiable resource calculation unit 313 illustrated in FIG. 2. The occupiable resource information 160 is expressed by integrating the physical resource information of the physical paths having the same combination of endpoint nodes. The occupiable resource information 160 includes information for specifying an abstract path, i.e. a route obtained by abstracting the physical resources included between two endpoint nodes 4-1, information for identifying the two endpoint nodes 4-1 of the abstract path, and the occupiable resource of the abstract path. The occupiable resource includes maximum band and maximum utilization rate.

The maximum band of an abstract path is the maximum value among the available bands of the physical paths associated with the abstract path. For example, the maximum band of the abstract path AP1 is 30 Mbps: the maximum value among the available bands of the physical paths PP1 and PP2 associated with the abstract path AP1, namely 20 and 30 Mbps.

The maximum utilization rate of an abstract path is the maximum value among the utilization rates of the physical paths associated with the abstract path. For example, the maximum utilization rate of the abstract path AP1 is 64.8%: the maximum value among the utilization rates of the physical paths PP1 and PP2 associated with the abstract path AP1, namely 56.7% and 64.8%.

The occupiable resource information 160 indicates that the abstract path AP2 is a route connecting the endpoint nodes 4-1-1 and 4-1-3, the maximum band thereof is 30 Mbps, and the maximum utilization rate thereof is 64.8%.

Returning to FIG. 2, the used band acquisition unit 314 acquires, from the monitor device 2, a time series of used bands of the endpoint nodes 4-1 associated with each service, and notifies the history information storage unit 315 of the used bands.

On the basis of the time series of used bands of the endpoint nodes 4-1 associated with each service provided by the used band acquisition unit 314, the history information storage unit 315 generates history information 170 indicating a time series of used bands for each combination of two endpoint nodes 4-1 and for each service, and stores the generated history information 170. The history information storage unit 315 also receives allocated physical resource information 230 from the physical resource allocation unit 322, and notifies the non-used resource calculation unit 316 of the history information 170 that matches the combination of the endpoint nodes 4-1 and the service.

FIG. 8 is a diagram illustrating an example of the history information 170 stored in the history information storage unit 315 illustrated in FIG. 2. The history information 170 includes information specifying a combination of the endpoint nodes 4-1, information specifying a service, and a time series of used bands.

For example, the history information 170 includes data indicating a time series of used bands between the endpoint node 4-1-1 and the endpoint node 4-1-2 during the provision of the service S1. The used bands are stored in association with information specifying the time. During the provision of the service Sl, the used band at time t1 is 6 Mbps, the used band at time t2 is 7 Mbps, and the used band at time t10 is 6 Mbps.

Returning to FIG. 2, the non-used resource calculation unit 316 generates non-used resource information 180 for each service and for each combination of the endpoint nodes 4-1 on the basis of the history information 170 provided by the history information storage unit 315 and the allocated physical resource information 230 provided by the physical resource allocation unit 322. The non-used resource calculation unit 316 notifies the shareable resource calculation unit 317 of the generated non-used resource information 180.

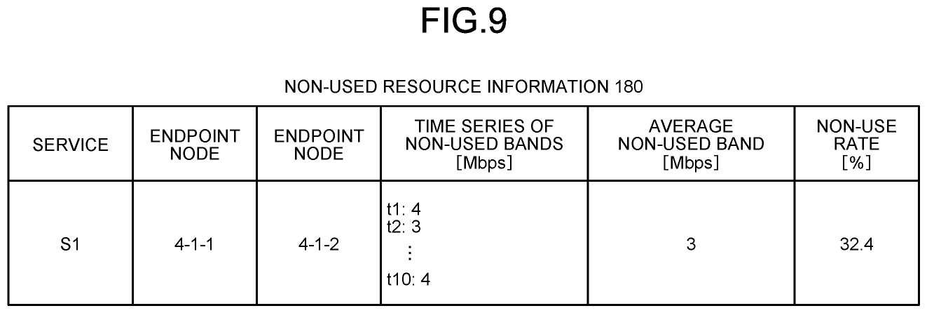

FIG. 9 is a diagram illustrating an example of the non-used resource information 180 generated by the non-used resource calculation unit 316 illustrated in FIG. 2. The non-used resource information 180 includes information specifying a service, information specifying a combination of the endpoint nodes 4-1, a time series of non-used bands, average non-used band, and non-use rate.

The time series of non-used bands indicates non-used parts of the resource allocated to the service. The non-used resource calculation unit 316 can calculate the non-used bands by subtracting the time series of used bands provided by the history information storage unit 315 from the allocated band indicated by the allocated physical resource information 230. For example, because the band allocated to the service S1 is 10 Mbps and the used band at time tl during the provision of the service S1 is 6 Mbps, the non-used band at time t1 is 4 Mbps.

The average non-used band is obtained by time-averaging the time series of non-used bands. The non-use rate is obtained by computing the probability that the time series of non-used bands is greater than or equal to the average non-used band, and multiplying the resultant value by the utilization rate indicated by the allocated physical resource information 230.

Returning to FIG. 2, the shareable resource calculation unit 317 generates shareable resource information 190 on the basis of the non-used resource information 180 provided by the non-used resource calculation unit 316, and notifies the available resource generation unit 318 of the generated shareable resource information 190.

The shareable resource information 190 indicates a shareable resource, i.e. a part of the resource already allocated to a service that is shareable with other services. The shareable resource is a resource which is not used in the allocated service; in other words, the shareable resource is a resource that may be used by other services when not used by the allocated service. For example, in a case where the shareable resource is allocated to a best-effort service, control is performed such that the traffic of the guaranteed service can be preferentially processed in the event of a traffic conflict between the guaranteed service and the best-effort service. As a result, it is possible to satisfy the requirements of the guaranteed service and also use the empty resource for the best-effort service.

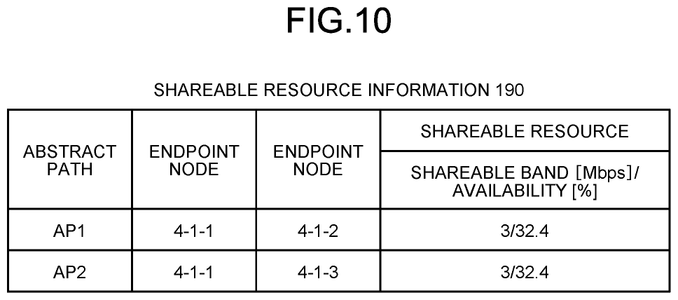

FIG. 10 is a diagram illustrating an example of the shareable resource information 190 generated by the shareable resource calculation unit 317 illustrated in FIG. 2. The shareable resource information 190 includes information specifying an abstract path, information specifying a combination of the endpoint nodes 4-1, and information indicating shareable resources. The information indicating shareable resources includes shareable band and availability. The shareable resource calculation unit 317 can use the average non-used band indicated by the non-used resource information 180 as the shareable band, and the non-use rate indicated by the non-used resource information 180 as the availability.

The shareable resource information 190 illustrated in FIG. 10 indicates that the abstract path AP1 is a route between the endpoint node 4-1-1 and the endpoint node 4-1-2, and the abstract path AP1 has a shareable band of 3 Mbps and an availability of 32.4%. The shareable resource information 190 illustrated in FIG. 10 also indicates that the abstract path AP2 is a route between the endpoint node 4-1-1 and the endpoint node 4-1-3, and the abstract path AP2 has a shareable band of 3 Mbps and an availability of 32.4%.

Returning to FIG. 2, the available resource generation unit 318 generates available resource information 200 by using the occupiable resource information 160 and the shareable resource information 190. The available resource generation unit 318 notifies the abstract resource allocation unit 321 of the generated available resource information 200.

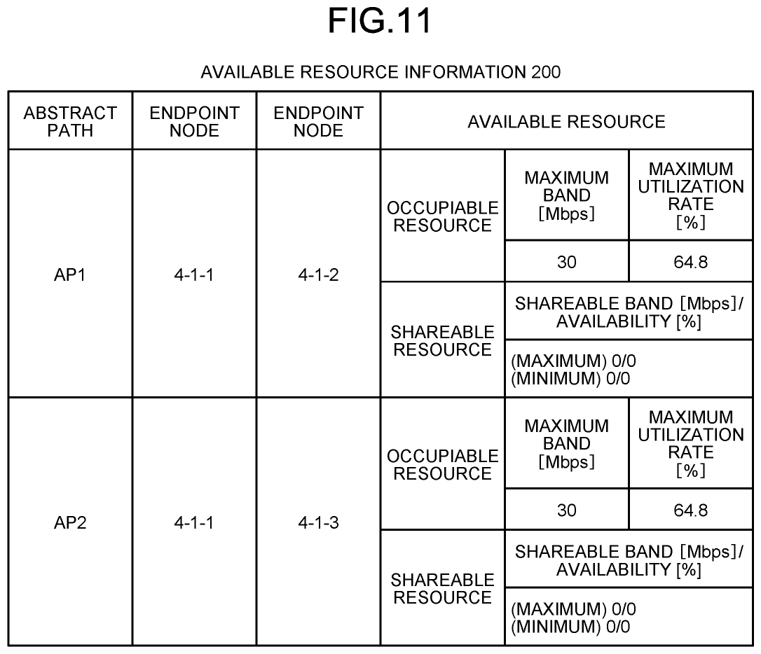

FIG. 11 is a diagram illustrating an example of the available resource information 200 generated by the available resource generation unit 318 illustrated in FIG. 2. The available resource information 200 includes information specifying an abstract path, information specifying a combination of the endpoint nodes 4-1, and information indicating available resources. The information indicating available resources includes information indicating occupiable resources and information indicating shareable resources.

The available resource generation unit 318 generates information indicating occupiable resources on the basis of the occupiable resource information 160. The information indicating occupiable resources includes maximum band and maximum utilization rate. The available resource generation unit 318 can generate information indicating shareable resources on the basis of the shareable resource information 190. The information indicating shareable resources includes shareable band and availability. The available resource generation unit 318 uses the average non-used band and non-use rate indicated by the non-used resource information 180 as the shareable band and availability, respectively. In addition, the shareable band and availability each have the items (maximum) and (minimum). Upon receiving multiple pieces of non-used resource information 180, the available resource generation unit 318 sets the average non-used band and the non-use rate in the non-used resource information 180 having the largest average non-used band in the item (maximum), and sets the average non-used band and the non-use rate in the non-used resource information 180 having the smallest average non-used band in the item (minimum).

The available resource information 200 illustrated in FIG. 11 indicates that the abstract path AP1 is a route between the endpoint node 4-1-1 and the endpoint node 4-1-2, and the available resource of the abstract path AP1 includes the occupiable resource with a maximum band of 30 and a maximum utilization rate of 64.8% and the shareable resource with a shareable band of zero.

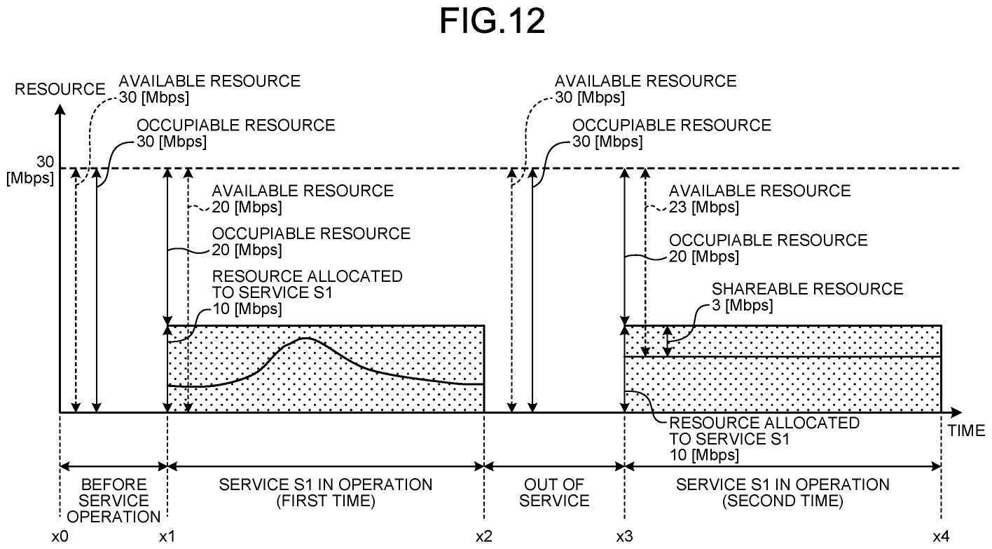

FIG. 12 is a diagram for explaining classification of the resources illustrated in FIG. 1. So far, the resources have been classified by using terms such as “occupiable resource”, “shareable resource”, and “available resource”. Now, the resources indicated by the respective terms will be described with a specific example.

Suppose that the occupiable resource at time x0 before service operation is 30 Mbps. At this point, there is no history information 170 generated; therefore, the shareable resource is 0 Mbps. At time x1, when the controller 3 allocates the service S1 10 Mbps from the occupiable resource, the post-allocation occupiable resource is 20 Mbps obtained by subtracting 10 Mbps from 30 Mbps. At this point, there is still no history information 170 generated; therefore, the shareable resource remains 0 Mbps.

During the period from time x1 to time x2 in which the service S1 is in operation, the monitor device 2 acquires the usage history of the service S1, and the controller 3 generates the history information 170 on the basis of the usage history. Once the operation of the service S1 ends, the resource allocated to the service S1 is released. Therefore, at time x2, the occupiable resource and the available resource return to the level at time x1 before allocation, specifically 30 Mbps.

At time x3, the operation of the service S1 is started again. Here, the controller 3 allocates the service S1 10 Mbps from the occupiable resource. In this case, the post-allocation occupiable resource is 20 Mbps obtained by subtracting 10 Mbps from 30 Mbps. The controller 3 generates the non-used resource information 180 on the basis of the history information 170. Here, suppose that the average non-used band indicated by the non-used resource information 180 is 3 Mbps. In this case, the shareable resource is 3 Mbps. As illustrated in FIG. 12, the shareable resource is a part of the resource allocated to the service S1 that may be used by services other than the service S1 when not used by the service Sl. In this case, the available resource is 23 Mbps obtained by adding the shareable resource of 3 Mbps to the occupiable resource of 20 Mbps.

Returning to FIG. 2, the abstract resource allocation unit 321 holds the available resource information 200 provided by the available resource generation unit 318. In addition, in response to receiving service request information from the orchestrator 1, the abstract resource allocation unit 321 determines whether resource allocation is possible, that is, whether it is possible to allocate a resource to the requested service indicated by the service request information, on the basis of the held available resource information 200.

For example, for a guaranteed service that requires an occupied resource secured, the abstract resource allocation unit 321 determines whether resource allocation is possible on the basis of the information indicating occupiable resources in the available resource information 200. In other words, the abstract resource allocation unit 321 determines whether resource allocation to the guaranteed service is possible on the basis of whether it is possible to allocate an occupiable resource to the guaranteed service.

In addition, for a best-effort service that does not require an occupied resource secured, the abstract resource allocation unit 321 determines whether resource allocation is possible using the information indicating occupiable resources and/or the information indicating shareable resources in the available resource information 200. In other words, the abstract resource allocation unit 321 determines whether resource allocation to the best-effort service is possible on the basis of whether it is possible to allocate an occupiable resource or a shareable resource to the best-effort service.

In response to determining that allocation is possible as a result of the allocation possibility determination, the abstract resource allocation unit 321 allocates a resource to the requested service, generates allocated abstract resource information, and notifies the physical resource allocation unit 322 of the generated allocated abstract resource information.

The physical resource allocation unit 322 selects, on the basis of the allocated abstract resource information provided, a physical path satisfying the request from among the physical paths associated with the abstract path, and allocates the physical resource to the requested service. The physical resource allocation unit 322 generates the allocated physical resource information 230, and notifies the physical resource generation unit 312, the history information storage unit 315, and the non-used resource calculation unit 316 of the generated allocated physical resource information 230.

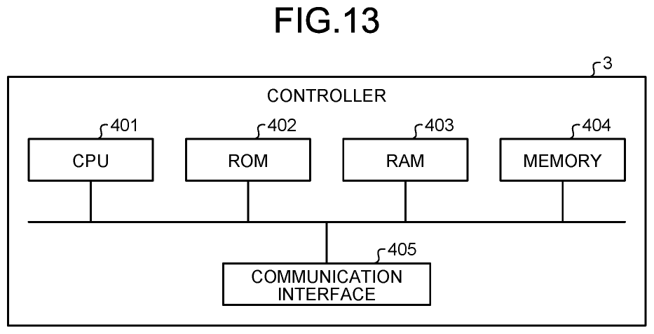

FIG. 13 is a diagram illustrating an exemplary physical configuration of the controller 3 illustrated in FIG. 2. The controller 3 is configured using a central processing unit (CPU) 401, a read only memory (ROM) 402, a random access memory (RAM) 403, a memory 404, and a communication interface 405. These components are connected via a bus.

The CPU 401 is in charge of overall processing and control of the controller 3. The ROM 402 stores computer programs such as a boot program, a communication program, and a data analysis program. The RAM 403 is used as a work area of the CPU 401. The memory 404 stores a computer program describing each function of the controller 3. The communication interface 405 is connected to the orchestrator 1, the monitor device 2, and the physical network 4. The CPU 401 reads and executes the program stored in the memory 404, thereby implementing each function of the controller 3. Note that the program stored in the memory 404 may be provided via a communication path or may be provided by being stored in a storage medium.

Note that the present embodiment is not limited to the described example in which the functions of the resource management unit 310 and the resource allocation unit 320 of the controller 3 are executed on the same piece of hardware. For example, a resource management device having the function of the resource management unit 310 and a resource allocation device having the function of the resource allocation unit 320 may be implemented using separate pieces of hardware.

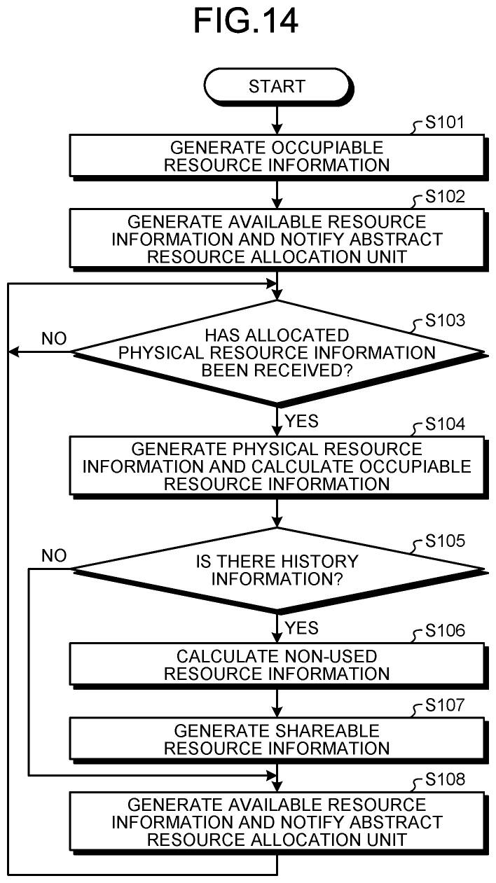

FIG. 14 is a flowchart for explaining the operation of the controller 3 illustrated in FIG. 2. First, the occupiable resource calculation unit 313 of the controller 3 generates the occupiable resource information 160 illustrated in FIG. 7 (step S101).

Subsequently, the available resource generation unit 318 generates the available resource information 200 illustrated in FIG. 11, and notifies the abstract resource allocation unit 321 of the generated available resource information 200 (step S102). The occupiable resources (illustrated in FIG. 7) calculated in step S101 is set in the field of occupiable resources in the available resource information 200. There is no shareable resource calculated at this point in time; therefore, the initial values of 0 Mbps and 0% are set in the field of shareable resources.

Steps S101 and S102 are performed before new service request information is received.

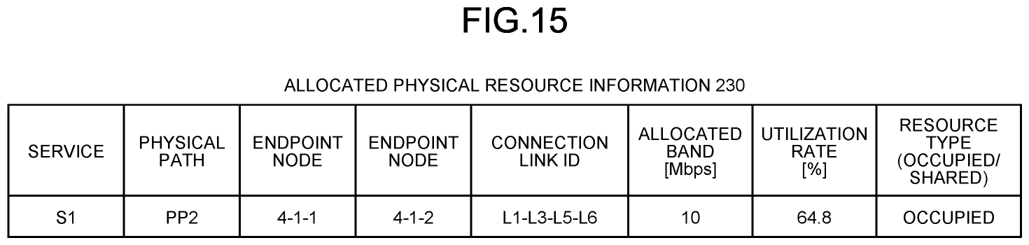

FIG. 15 is a diagram illustrating an example of the allocated physical resource information 230 received in step S103 of FIG. 14. Next, the operation in which the resource management unit 310 receives the allocated physical resource information 230 illustrated in FIG. 15 from the resource allocation unit 320 will be described. The allocated physical resource information 230 indicates that the service S1 has been allocated 10 Mbps of the band of the physical path PP2.

The resource management unit 310 determines whether the allocated physical resource information 230 has been received (step S103). In response to determining that the allocated physical resource information 230 has not been received (step S103: No), the resource management unit 310 repeats step S103. In response to receiving the allocated physical resource information 230 (step S103: Yes), the physical resource generation unit 312 generates physical resource information 150-2 based on the allocated physical resource information 230, and the occupiable resource calculation unit 313 calculates occupiable resource information 160-2 (step S104).

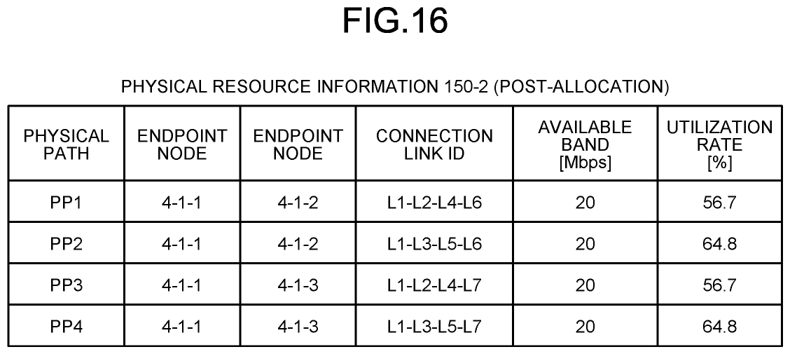

FIG. 16 is a diagram illustrating an example of the physical resource information 150-2 generated in step S104 of FIG. 14. The physical resource generation unit 312 can obtain the post-allocation available band 20 Mbps by subtracting the allocated band 10 Mbps from the available band 30 Mbps of the physical path PP2 and the physical path PP4.

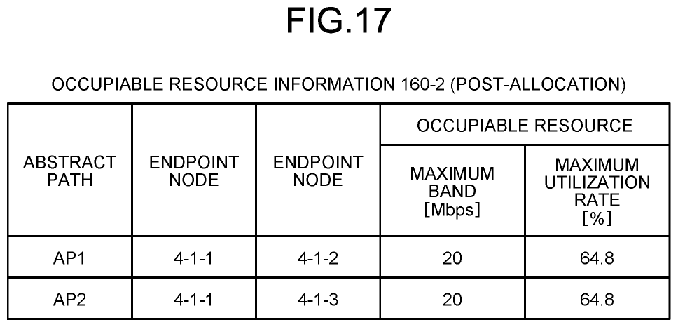

FIG. 17 is a diagram illustrating an example of the occupiable resource information 160-2 generated in step S104 of FIG. 14. The occupiable resource calculation unit 313 generates the post-allocation occupiable resource information 160-2 on the basis of the post-allocation physical resource information 150-2. Specifically, the maximum band in the occupiable resource information 160-2 is updated to the available band 20 Mbps indicated by the physical resource information 150-2.

Subsequently, the history information storage unit 315 checks whether there is the history information 170 that matches the service S1 and the combination of the endpoint node 4-1-1 and the endpoint node 4-1-2 included in the allocated physical resource information 230 (step S105).

When there is the history information 170 (step S105: Yes), the history information storage unit 315 notifies the non-used resource calculation unit 316 of the part of the history information 170 that matches the service S1 and the combination of the endpoint node 4-1-1 and the endpoint node 4-1-2 included in the allocated physical resource information 230 received. Here, it is assumed that the history information 170 illustrated in FIG. 8 has already been generated. The non-used resource calculation unit 316 calculates the non-used resource information 180 on the basis of the received part of the history information 170 and the allocated physical resource information 230 provided in step S103 (step S106).

Suppose that the average non-used band is 3 Mbps, for example. The non-use rate is obtained by multiplying the probability that the time series of non-used bands is greater than or equal to the average non-used band by the utilization rate indicated by the allocated physical resource information 230 received from the resource allocation unit 320. For example, when the probability that the time series of non-used bands is greater than or equal to the average non-used band is 50% and the utilization rate indicated by the allocated physical resource information 230 is 64.8%, the non-use rate is 0.5×0.648×100=32.4%. The non-used resource information 180 calculated here is illustrated in FIG. 9.

Subsequently, the shareable resource calculation unit 317 generates the shareable resource information 190 on the basis of the non-used resource information 180 (step S107). The shareable resource information 190 generated here is illustrated in FIG. 10. The shareable band is set to 3 Mbps, which is the average non-used band indicated by the non-used resource information 180, and the availability is set to 32.4%, which is the non-use rate indicated by the non-used resource information 180.

When there is no history information (step S105: No), steps S106 and S107 are skipped.

After step S107 is executed or steps 5106 and S107 are skipped, the available resource generation unit 318 generates post-allocation available resource information 200-2 on the basis of the occupiable resource information 160-2 and the shareable resource information 190, and notifies the abstract resource allocation unit 321 of the generated available resource information 200-2 (step S108).

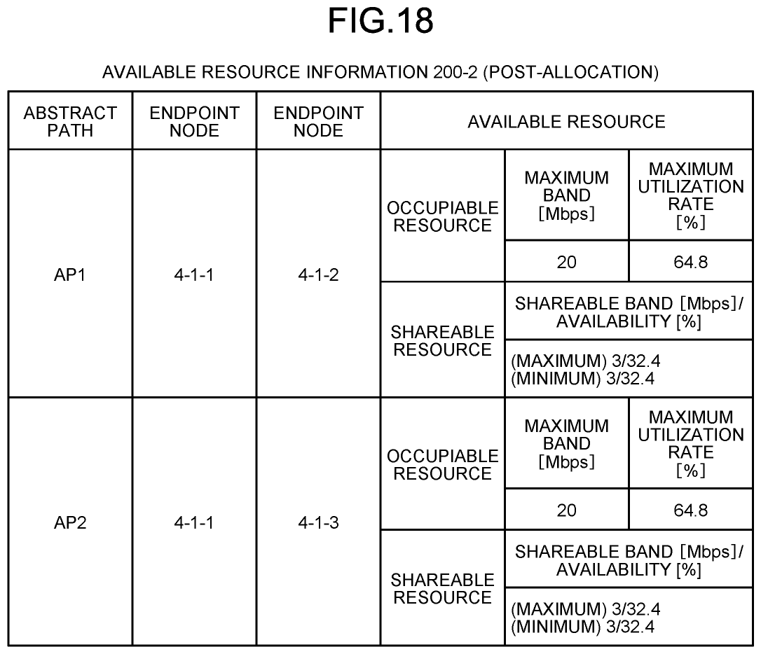

FIG. 18 is a diagram illustrating an example of the available resource information 200-2 generated in step S108 of FIG. 14. FIG. 18 illustrates an example of the available resource information 200-2 generated in step S108 after step S107 is performed. The available resources in the available resource information 200-2 include information indicating occupiable resources and information indicating shareable resources.

After step S108 is executed, the operation returns to step S103. Note that a time series of used bands of each endpoint node 4-1 associated with each service may be acquired from the monitor device 2 after the service operation, in which case the history information 170 is updated, which is not illustrated in FIG. 14.

As described above, the controller 3, which is the resource management device according to the first embodiment, includes: the history information storage unit 315 that stores, for each combination of endpoint nodes 4-1 constituting endpoints of a network and for each type of service, the history information 170 indicating used bands previously required for providing a service; the non-used resource calculation unit 316 that calculates the non-used resource information 180 on the basis of the history information 170 stored corresponding to a first service that is a service already allocated a resource, the non-used resource information 180 indicating a resource that is not used while the first service is provided; and the available resource generation unit 318 that generates the available resource information 200 on the basis of the non-used resource information 180, the available resource information 200 indicating a resource including a shareable resource and available to a second service to be newly provided, the shareable resource being a part, shareable with the second service, of the resource already allocated to the first service.

The resource allocation unit 320 can determine whether resource allocation to the service to be newly provided is possible by comparing the available resource information 200 with the requirements of the service to be newly provided; therefore, the time required for determining whether resource allocation is possible can be shortened. In particular, the available resource information 200 includes not only the resource that is not allocated to the first service but also the shareable resource that is a part of the resource already allocated to the first service that is shareable with the second service. Therefore, waste of resources can be reduced.

In addition, the controller 3 includes the occupiable resource calculation unit 313 that generates the occupiable resource information 160 indicating an occupiable resource that is not allocated to the first service, and the shareable resource calculation unit 317 that generates the shareable resource information 190 indicating the shareable resource on the basis of the non-used resource information 180. The available resource generation unit 318 generates the available resource information 200 including the occupiable resource information 160 and the shareable resource information 190. The controller 3 having this configuration is capable of managing the shareable resource separately from the occupiable resource. Therefore, the resource allocation unit 320 that allocates resources using the available resource information 200 can determine whether to allocate the shareable resource or the occupiable resource to the service on the basis of the requirements of the service.

### Second Embodiment

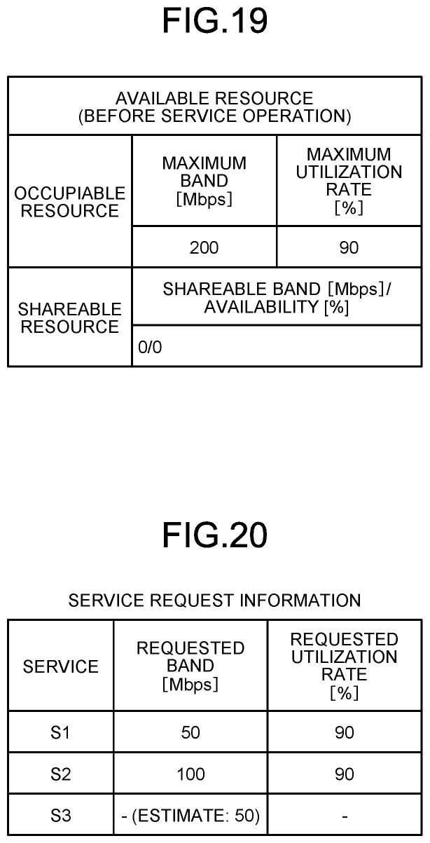

The first embodiment has shown an example in which one service is allocated a resource. A second embodiment describes a case where a plurality of services are allocated resources with reference to FIGS. 19 to 25. For the sake of simplicity, FIGS. 19 to 25 illustrate only the items necessary for this description. In addition, the present embodiment shows an example in which a plurality of services are accommodated in one abstract path.

In the second embodiment, the configuration of the system 100 and the configuration of the controller 3 are similar to those described with reference to FIGS. 1 and 2, and thus, detailed description thereof is omitted here.

FIG. 19 is a diagram illustrating a first example of available resources calculated in the second embodiment. Before service operation, the occupiable resource has a maximum band of 200 Mbps and a maximum utilization rate of 90%. The shareable resource has a shareable band of 0 Mbps and an availability of 0%.

FIG. 20 is a diagram illustrating service requirements required in the second embodiment. The service S1 has a requested band of 50 Mbps and a requested utilization rate of 90%. The service S2 has a requested band of 100 Mbps and a requested utilization rate of 90%. The estimated value of the requested band of the service S3 is 50 Mbps.

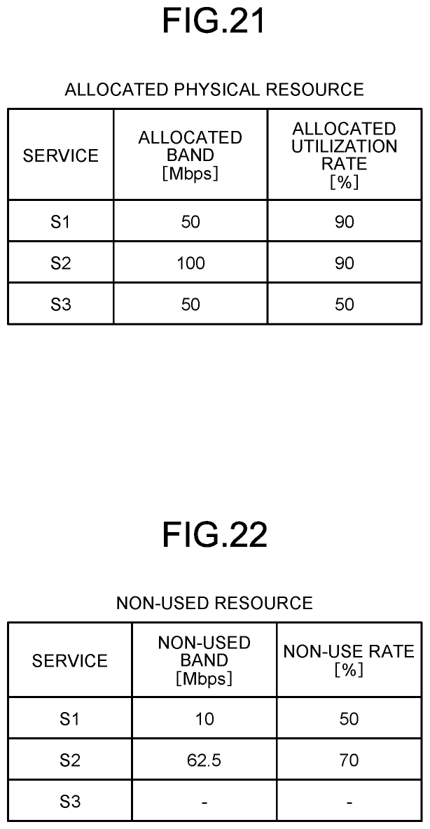

FIG. 21 is a diagram illustrating physical resources allocated when the services illustrated in FIG. 20 are requested. The service S1 has an allocated band of 50 Mbps and an allocated utilization rate of 90%. The service S2 has an allocated band of 100 Mbps and an allocated utilization rate of 90%. The service S3 has an allocated band of 50 Mbps and an allocated utilization rate of 50%.

FIG. 22 is a diagram illustrating an example of non-used resources calculated in the second embodiment. The service S1 has a non-used band of 10 Mbps and a non-use rate of 50%. The service S2 has a non-used band of 62.5 Mbps and a non-use rate of 70%.

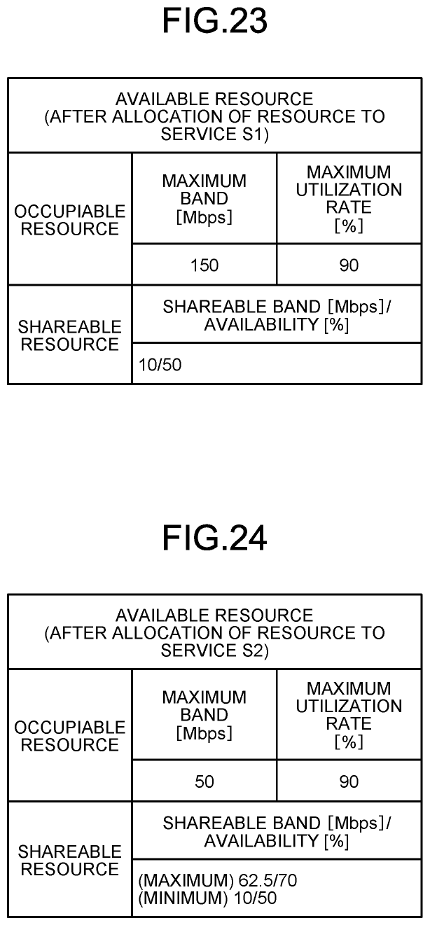

FIG. 23 is a diagram illustrating a second example of available resources calculated in the second embodiment. The second example shows the available resources left after the allocation of the resource illustrated in FIG. 21 to the service Sl. The maximum band of the occupiable resource is 150 Mbps obtained by subtracting the allocated amount of 50 Mbps from the post-allocation amount of 200 Mbps. The shareable resource is 10 Mbps obtained by adding 10 Mbps, which is the non-used resource of the service S1, to 0 Mbps.

FIG. 24 is a diagram illustrating a third example of available resources calculated in the second embodiment. The third example shows the available resources left after the allocation of the resource illustrated in FIG. 21 to the service S2. The maximum band of the occupiable resource is 50 Mbps obtained by subtracting the allocated amount of 100 Mbps from 150 Mbps. The non-used resource of the service S2 is added to the shareable resource. Here, because multiple pieces of non-used resource information have been provided, the non-used band and the non-use rate of the service S2 having the largest non-used band among the multiple pieces of non-used resource information are set in the item (maximum), and the non-used band and the non-use rate of the service S1 having the smallest non-used band are set in the item (minimum).

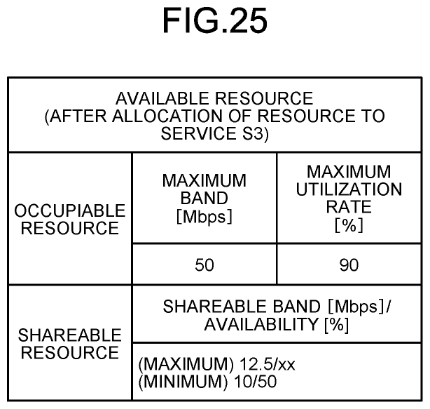

FIG. 25 is a diagram illustrating a fourth example of available resources calculated in the second embodiment. The fourth example shows the available resources left after the allocation of the resource illustrated in FIG. 21 to the service S3. Because the service S3 is a best-effort service, the estimated band is allocated from the shareable resource. In this case, the occupiable resource remains unchanged from FIG. 24, and the shareable band of the shareable resource is 12.5 Mbps obtained by subtracting the estimated band of 50 Mbps from 62.5 Mbps. In this case, the value of the availability is obtained by multiplying the probability that the time series of non-used bands is greater than or equal to the shareable band of 12.5 Mbps by the value of the utilization rate indicated by the allocated physical resource information.

The present embodiment is not limited to the above-described example in which the shareable resource is allocated to the best-effort service. The shareable resource may be allocated to a service of an intermediate type between guaranteed and best-effort services, for example, a service which only requires that a total band of 10 Mbps be secured from the start to the end of the service, and does not include any requirement of delay or availability.

As described above, in the second embodiment, the time required for determining whether resource allocation is possible can be shortened as in the first embodiment.

### Third Embodiment

A third embodiment is similar in functional configuration to the first embodiment and the second embodiment, and has different definitions of non-used resource information and shareable resource information.

In the third embodiment, the average non-used band in the non-used resource information 180 is defined as the allocated band indicated by the allocated physical resource information 230 received from the physical resource allocation unit 322, and the non-use rate in the non-used resource information 180 is defined as the probability that the allocated band indicated by the allocated physical resource information 230 can be secured.

In this case, the non-use rate is obtained by first computing the probability that the time series of non-used bands is greater than or equal to the average non-used band, and multiplying the resultant value by the utilization rate indicated by the allocated physical resource information 230.

The above-mentioned definitions of the average non-used band and the non-use rate enable the abstract resource allocation unit 321 to recognize the maximum band that can be used as a shareable resource and the probability that the band can be used.

### Fourth Embodiment

A fourth embodiment is similar in functional configuration to the first embodiment and the second embodiment, and has different definitions of non-used resource information and shareable resource information.

In the fourth embodiment, the average non-used band in the non-used resource information 180 is defined as a predetermined band value, and the non-use rate is defined as the probability that the set band can be secured.

In this case, the non-use rate is obtained by first computing the probability that the time series of non-used bands is greater than or equal to the average non-used band, and multiplying the resultant value by the utilization rate indicated by the allocated physical resource information 230.

The above-mentioned definitions of the average non-used band and the non-use rate enable the abstract resource allocation unit 321 to recognize the probability that the set band can be used. For example, it is desirable that the predetermined band value be a representative band value of service requirements.

The resource management device according to the disclosure can achieve the effect of shortening the time required for determining whether resource allocation is possible.

The configurations described in the above-mentioned embodiments indicate examples. The configurations can be combined with another well-known technique, and some of the configurations can be omitted or changed in a range not departing from the gist.

What is claimed is:

1. A resource management device comprising:
a history information memory to store, for each combination of endpoint nodes constituting endpoints of a network and for each type of service, history information indicating used bands previously required for providing a service;
a non-used resource calculator to calculate non-used resource information on the basis of the history information stored corresponding to a first service that is a service already allocated a resource, the non-used resource information indicating a resource that is not used while the first service is provided;
an available resource generator to generate available resource information on the basis of the non-used resource information, the available resource information indicating an available resource including a shareable resource and available to a second service to be newly provided, the shareable resource being a part, shareable with the second service, of the resource already allocated to the first service;
an occupiable resource calculator to generate occupiable resource information indicating an occupiable resource that is not allocated to the first service; and
a shareable resource calculator to generate shareable resource information indicating the shareable resource on the basis of the non-used resource information, wherein
the non-used resource information includes an average non-used band indicating a non-used resource that is a part, not used while the first service is provided, of the resource already allocated to the first service,
the shareable resource information includes, for each combination of the endpoint nodes, a shareable band that is a band of the shareable resource, and includes, for each combination of the endpoint nodes, a non-use rate that is a probability that the shareable band is available,
the available resource generator generates the available resource information including the occupiable resource information and the shareable resource information, and
the shareable resource calculator uses the average non-used band as the shareable band, and calculates the non-use rate by multiplying a probability that a time series of non-used bands is greater than or equal to the average non-used band by a utilization rate of the resource allocated to the first service.

2. The resource management device according to claim 1, wherein the shareable resource calculator calculates the average non-used band by subtracting an average value of the used bands indicated by the history information from a band of the resource already allocated to the first service.

3. The resource management device according to claim 1, wherein
the shareable resource information includes a maximum shareable band that is a maximum value of the shareable band that is the band of the shareable resource, availability of the maximum shareable band, a minimum shareable band that is a minimum value of the shareable band, and availability of the minimum shareable band, and
the shareable resource calculator uses the non-use rate as availability.

4. The resource management device according to claim 1, wherein the average non-used band is a band allocated to the first service.

5. The resource management device according to claim 1, wherein the average non-used band is a set band having a predetermined value.

6. The resource management device according to claim 1, further comprising
a physical resource generator to generate, for each combination of the endpoint nodes, physical resource information indicating a physical resource held by a route connecting the endpoint nodes, wherein
the occupiable resource calculator calculates the occupiable resource available by integrating the physical resource information for each combination of the endpoint nodes.

7. A control circuit for controlling a resource management device that manages resources in a network, the control circuit causing the resource management device to execute:
storing, for each combination of endpoint nodes constituting endpoints of the network and for each type of service, history information indicating used bands previously required for providing a service;
calculating non-used resource information on the basis of the history information stored corresponding to a first service that is a service already allocated a resource, the non-used resource information indicating a resource that is not used while the first service is provided;
generating available resource information on the basis of the non-used resource information, the available resource information indicating a resource including a shareable resource and available to a second service to be newly provided, the shareable resource being a part, shareable with the second service, of the resource already allocated to the first service;
generating occupiable resource information indicating an occupiable resource that is not allocated to the first service; and
generating shareable resource information indicating the shareable resource on the basis of the non-used resource information, wherein
the non-used resource information includes an average non-used band indicating a non-used resource that is a part, not used while the first service is provided, of the resource already allocated to the first service,
the shareable resource information includes, for each combination of the endpoint nodes, a shareable band that is a band of the shareable resource, and includes, for each combination of the endpoint nodes, a non-use rate that is a probability that the shareable band is available,
the generating available resource information includes generating the available resource information including the occupiable resource information and the shareable resource information, and
the generating shareable resource information includes using the average non-used band as the shareable band, and calculating the non-use rate by multiplying a probability that a time series of non-used bands is greater than or equal to the average non-used band by a utilization rate of the resource allocated to the first service.

8. A non-transitory storage medium storing a program for controlling a resource management device that manages resources in a network, the program causing the resource management device to execute:
storing, for each combination of endpoint nodes constituting endpoints of the network and for each type of service, history information indicating used bands previously required for providing a service;
calculating non-used resource information on the basis of the history information stored corresponding to a first service that is a service already allocated a resource, the non-used resource information indicating a resource that is not used while the first service is provided;
generating available resource information on the basis of the non-used resource information, the available resource information indicating a resource including a shareable resource and available to a second service to be newly provided, the shareable resource being a part, shareable with the second service, of the resource already allocated to the first service;
generating occupiable resource information indicating an occupiable resource that is not allocated to the first service; and
generating shareable resource information indicating the shareable resource on the basis of the non-used resource information, wherein
the non-used resource information includes an average non-used band indicating a non-used resource that is a part, not used while the first service is provided, of the resource already allocated to the first service,
the shareable resource information includes, for each combination of the endpoint nodes, a shareable band that is a band of the shareable resource, and includes, for each combination of the endpoint nodes, a non-use rate that is a probability that the shareable band is available,
the generating available resource information includes generating the available resource information including the occupiable resource information and the shareable resource information, and
the generating shareable resource information includes using the average non-used band as the shareable band, and calculating the non-use rate by multiplying a probability that a time series of non-used bands is greater than or equal to the average non-used band by a utilization rate of the resource allocated to the first service.

9. A resource management method for a resource management device that manages resources in a network, the resource management method comprising:
storing, for each combination of endpoint nodes constituting endpoints of the network and for each type of service, history information indicating used bands previously required for providing a service;
calculating non-used resource information on the basis of the history information stored corresponding to a first service that is a service already allocated a resource, the non-used resource information indicating a resource that is not used while the first service is provided;
generating available resource information on the basis of the non-used resource information, the available resource information indicating a resource including a shareable resource and available to a second service to be newly provided, the shareable resource being a part, shareable with the second service, of the resource already allocated to the first service;
generating occupiable resource information indicating an occupiable resource that is not allocated to the first service; and
generating shareable resource information indicating the shareable resource on the basis of the non-used resource information, wherein
the non-used resource information includes an average non-used band indicating a non-used resource that is a part, not used while the first service is provided, of the resource already allocated to the first service,
the shareable resource information includes, for each combination of the endpoint nodes, a shareable band that is a band of the shareable resource, and includes, for each combination of the endpoint nodes, a non-use rate that is a probability that the shareable band is available,
the generating available resource information includes generating the available resource information including the occupiable resource information and the shareable resource information, and
the generating shareable resource information includes using the average non-used band as the shareable band, and calculating the non-use rate by multiplying a probability that a time series of non-used bands is greater than or equal to the average non-used band by a utilization rate of the resource allocated to the first service.
